(19) United States
(12) Patent Application Publication
(10) Pub. No.: US 2008/0006520 A1
(43) Pub. Date: Jan. 10, 2008

(54) Method and system for accomplishing flash or fast pyrolysis with carbonaceous materials

(76) Inventors: Phillip C. Badger, Florence, AL (US); Peter B. Fransham, Ottawa (CA)

Correspondence Address: WELSH & FLAXMAN LLC, 2000 DUKE STREET, SUITE 100, ALEXANDRIA, VA, 22314, US

(21) Appl. No.: 11/480,915

(22) Filed: Jul. 6, 2006

(51) Int. Cl. C10B 51/00; C01B 3/32

(52) U.S. Cl. 202/96; 48/127.3; 202/202; 202/214; 422/285

(57) ABSTRACT

A system for the conversion of carbonaceous feedstocks into useful sources for energy, chemicals, or other material includes a dryer into which the carbonaceous feedstock is placed and a reactor chamber in communication with the dryer for receiving dried feedstock and heat carrier for further processing of the feedstock in the generation of useful sources for energy, chemicals, or other material. The system also includes a char separation and recovery mechanism linked to the reactor chamber for separating char produced as a result of processing of feedstock within the reactor chamber from heat carrier, a condenser in communication with the reactor chamber for receiving gas and vapor from the reactor chamber to recover a liquid product, and a furnace linked to the char separation and recovery mechanism for burning char as needed for operation of the present system.

### BACKGROUND OF THE INVENTION

1. Field of the Invention

The invention relates to a system for processing various carbonaceous feedstocks into useful energy, such as, gaseous, liquid, and char products. In particular, the invention relates to a system for optimizing the decomposition of carbonaceous feedstocks using heat in an oxygen depleted atmosphere in a manner that results in the production of useful products. Usable feedstocks may include carbonaceous waste materials or residues.

2. Description of the Prior Art

Current worldwide demands for energy sources necessitate that additional energy sources be developed for efficiently and cost effectively providing energy. Researchers have attempted to develop renewable oil sources by converting carbonaceous feedstock, for example, biomass materials, into useful energy sources. Many of these processes rely upon the thermal decomposition, for example, pyrolysis, of the feedstock for converting the feedstock into readily usable energy sources.

While some success has been found through the utilization of prior systems, a need still exists for an improved and more efficient process for the conversion of carbonaceous feedstock to useful energy sources. The present invention provides such a process.

### SUMMARY OF THE INVENTION

It is, therefore, an object of the present invention to provide a system for the conversion of carbonaceous feedstocks into useful sources for energy, chemicals, or other materials. The system includes a reactor chamber for receiving carbonaceous feedstock and heat carrier for processing of the feedstock in the generation of useful sources for energy, chemicals, or other material, a char separation and recovery mechanism linked to the reactor chamber for separating char produced as a result of processing of feedstock within the reactor chamber from heat carrier, a condenser in communication with the reactor chamber for receiving gas and vapor from the reactor chamber to separate and recover a liquid product and non-condensable gases, and a furnace linked to the char separation and recovery mechanism for burning the gases and char as needed to provide energy for operation of the present system.

It is also an object of the present invention to provide a system for the conversion of carbonaceous feedstock into useful sources for energy, chemicals, or other materials wherein the liquid product generated by the condenser is bio oil.

It is another object of the present invention to provide a system for the conversion of carbonaceous feedstock into useful sources for energy, chemicals, or other materials including a dryer in communication with the reactor chamber.

It is a further object of the present invention to provide a system for the conversion of carbonaceous feedstock into useful sources for energy, chemicals, or other materials wherein a feed mechanism transfers the feedstock from the dryer to the reactor chamber.

It is also another object of the present invention to provide a system for the conversion of carbonaceous feedstock into useful sources for energy, chemicals, or other materials wherein the feed mechanism includes a central air lock between first and second feed sections.

It is another object of the present invention to provide a method for the conversion of carbonaceous feedstocks into useful sources for energy, chemicals, or other materials. The method is achieved by processing carbonaceous feedstock and heat carrier in a reactor chamber, separating char produced as a result of processing of feedstock within the reactor chamber from heat carrier, separating and recovering liquid product and non-condensable gases from gas and vapor emitted by the reactor chamber, and burning the gases and char as needed to provide energy for operation of the method.

It is a further object of the present invention to provide a method including the step of drying the feedstock prior to the step of processing in the reactor chamber.

Other objects, advantages and salient features of the invention will become apparent from the following detailed description, which taken in conjunction with the annexed drawings, discloses a preferred, but non-limiting, embodiment of the subject invention.

### BRIEF DESCRIPTION OF THE DRAWINGS

FIG. 1 is an overview of the present system.

FIG. 2 is a schematic of the present system in accordance with a preferred embodiment.

FIG. 3 is a schematic showing a feeding mechanism in accordance with the present invention.

FIGS. 4, 5, 6 and 7 show various char separation systems for use in accordance with the present invention.

FIG. 8 is a schematic showing a heat exchanger for use in conjunction with the return heat carrier to the reactor.

FIG. 9 is a side view of the char/syngas burner in accordance with a preferred embodiment of the present invention.

FIGS. 10 and 11 show potential reactor chamber designs for use in accordance with the present invention.

FIG. 12 shows a schematic view of a condenser for use in accordance with the present invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

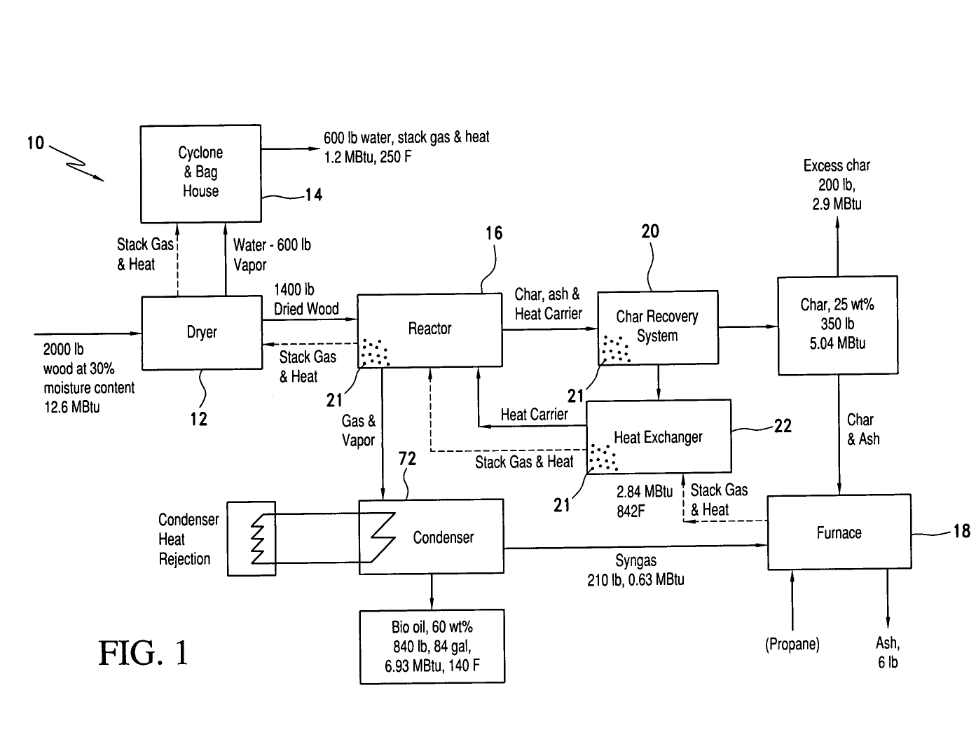

Referring to FIG. 1, a flow chart of the present system and method for the conversion of carbonaceous feedstocks into char, useful liquids, gases, and other useful byproducts is shown. The resulting char and byproducts may then be used in various applications for the creation of heat and energy, or for other applications. As those skilled in the art will appreciate, the term “char” is meant to refer to carbon-rich matter that has been partially, but incompletely, combusted when subjected to heat in a controlled manner for a predetermined period of time. The application of heat to the feedstock in an oxygen depleted atmosphere results in the removal of some hydrogen, oxygen and carbon from the feedstock, leaving a char material primarily composed of carbon.

The present system 10 employs a dryer 12 into which carbonaceous feedstock, such as biomass, for example, wood at 30% moisture content and having approximately 12.6 MBtu of available energy, is placed. In order for the present system 10 to work properly, the feedstock must be ground to a fine consistency and dried. As those skilled in the art will certainly appreciate, the equipment used in grinding and drying of the feedstock is readily available, and various known devices may be employed for this purpose.

From the dryer 12, which may be heated from waste heat from an associated reactor chamber 16 or from another source, the dried feedstock is forwarded to the reactor chamber 16 with the emissions from the dryer 12 forwarded to a cyclone and/or bag house 14 (or other suitable device which removes particulates from the emission stream). It is contemplated that where the drying of carbonaceous materials may generate other emissions, for example, volatile organic compounds (VOCs), the cyclone and/or bag house 14 may be replaced with a wet scrubber or other suitable device known to those skilled in the art for the control of emissions. The dried biomass, for example, the dried wood, is transferred to the reactor chamber 16 which operates at approximately 350° C. to approximately 560° C. While drying of the feedstock is disclosed in accordance with a preferred embodiment of the present invention, those skilled in the art will appreciate that drying is not always necessary as some feedstock arrives dry enough for processing and the drying step may be skipped.

Gas and vapor from the reactor chamber 16 is passed through a condenser system 72 as discussed below in greater detail and the vapor is condensed to recover the liquid product. This liquid product is known by several names including bio oil, pyrolysis oil, wood distillate, and other names, and is composed of water and numerous chemicals. Useful gas, for example, syngas, is collected as it exits the condenser system 72. The bio oil is collected for later use and the syngas is forwarded to a furnace 18, where it is combusted to provide at least part of the energy for the system 10. Alternatively, the syngas could be used to fuel an engine to generate heat and electricity for the system. As those skilled in the art will appreciate, syngas (or synthesis gas) is the non-condensable gas portion of the gas and vapor stream from the reactor chamber 16 and has energy value. The bio oil may be used as an energy source or a source of chemicals, or for other applications, in much the same manner as petroleum products.

The char, ash and heat carrier are transferred from the pyrolytic reactor 16 to the char separation and recovery system 20. The char separation and recovery system 20 separates the heat carrier (HC) 21, which is transferred to a heat exchanger 22 to be reheated and recirculated to the reactor chamber 16, and the char, which is collected and, to the extent necessary needed for process heat, burned in the furnace 18. Any char not needed for process heat becomes a byproduct. The hot heat carrier 21, when mixed with the feedstock in the reactor chamber 16, provides the thermal energy for pyrolysis to occur in the reactor chamber 16 without the introduction of oxygen into the reactor chamber 16.

With this in mind, and in accordance with a preferred embodiment of the present invention, the method is achieved by drying carbonaceous feedstock (if necessary), processing the dried carbonaceous feedstock and heat carrier 21 in a reactor chamber 16, separating char produced as a result of processing of feedstock within the reactor chamber 16 from heat carrier 21, separating and recovering liquid product and non-condensable gases from gas and vapor emitted by the reactor chamber 16, and burning the non-condensable gases and char as needed to provide energy for operation of the method.

The breakdown of biomass during the present process is shown in FIG. 1. In particular, beginning with 2,000 lb of wood at 30% moisture content results in approximately 600 lb water, stack gas and heat, 350 lbs of char, 6 lbs of ash, 840 lbs of bio oil, and 210 lbs of syngas. The available energy is also shown in FIG. 1, and includes 1.2 MBtu of energy released through the cyclone and/or bag house 14, 2.9 MBtu of energy in excess char gathered from the char recovery system 20, 5.04 MBtu of energy in char passed to the furnace 18, 2.84 MBtu of energy release from the furnace 18 and transferred back to the reactor 16, 6.93 MBtu of energy in bio oil generated by the condenser 72 and 0.63 MBtu of energy in syngas transferred from the condenser to the furnace 18.

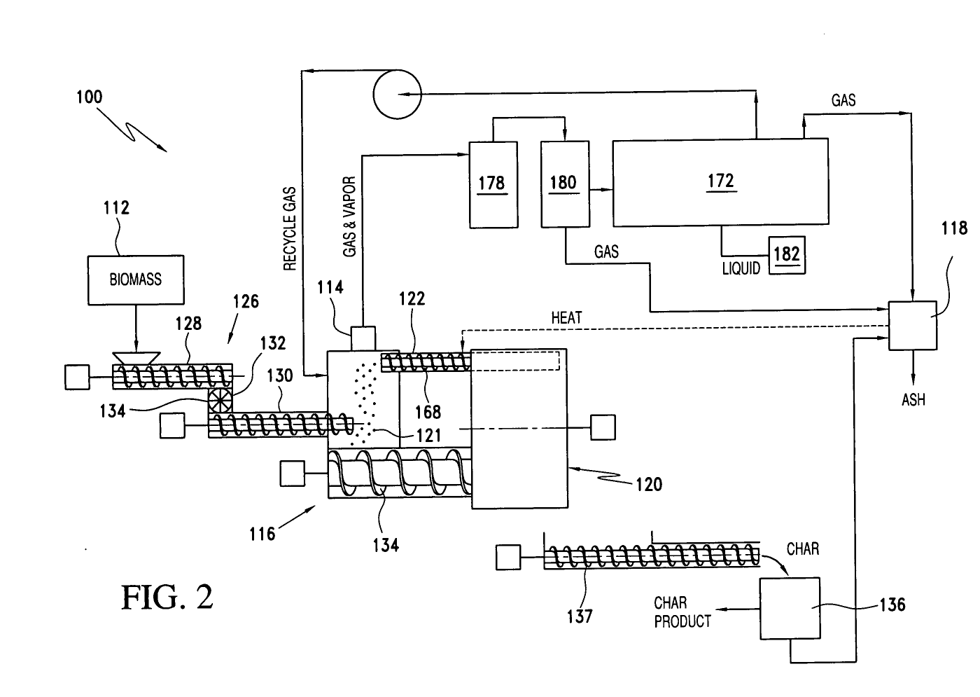

Referring to FIG. 2, a preferred embodiment for the present system 100 for the pyrolytic conversion of carbonaceous feedstock (such as waste carbonaceous materials including biomass) into useful sources for energy, chemicals, and other materials, for example liquids, char and gases used in the production of energy is disclosed. In accordance with a preferred embodiment of the present invention, the feedstock may include many types of carbonaceous materials, including, but not limited to, various types of wood and wood residues such as sawdust, wood chips, wood shavings, bark, construction and demolition debris, and post consumer wood waste; paper, cardboard, straw, hay, grasses, manure, chicken litter, bagasse, tires, tire crumb, plastic, automobile fluff, treated wood, sewage and other types of sludge, herbaceous crops and residues including processing residues, food processing residues, peat, municipal solid waste, certain industrial wastes, heavy hydrocarbons such as from the petroleum industry, and coal fines.

In accordance with this embodiment, and after drying as discussed above, the carbonaceous feedstock is fed into a storage hopper 112. The carbonaceous feedstock is directed from the storage hopper 112 by virtue of a feed mechanism, for example, and in accordance with a preferred embodiment, a rotating feed auger 126. In accordance with a preferred embodiment, the feedstock is fed to the reactor chamber 116 via a rotating feed auger 126 such as a conventional centerless auger (i.e., shaftless auger) in a tube or one or more side-by-side augers in a common trough. The use of the centerless or one or more side-by-side augers may facilitate feeding of particles that are irregular in shape or rod-shaped, such as short pieces of straw or grass. The distance is increased between the feed point and the reactor chamber 116 so as to reduce burn back and to form a better air seal, since it is necessary to maintain oxygen deleted conditions inside the reactor chamber 116. Where a single auger is used, a relief, such as, a raised ridge may be added to the inside of the end of the auger tube where the auger enters the reactor chamber 116 to increase the degree of feedstock compression and better facilitate the formation of an air seal. Although various auger systems are discussed above for feeding feedstock in accordance with a preferred embodiment of the present invention, other feed mechanisms may be employed without departing from the spirit of the present invention.

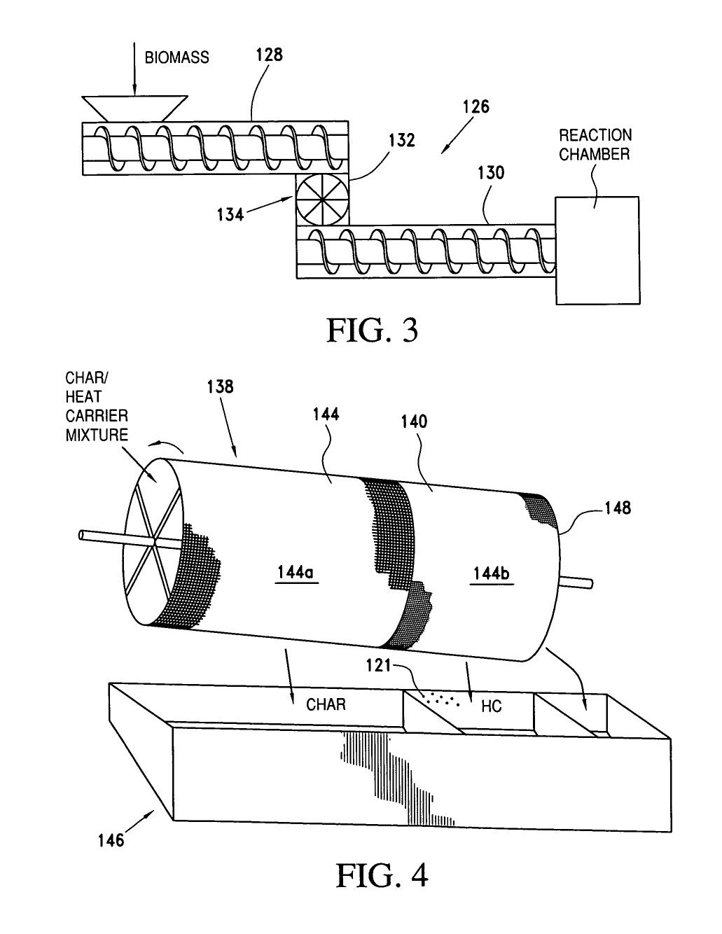

As shown FIGS. 2 and 3, the auger 126 is composed of first and second auger sections 128, 130 with a motorized star wheel airlock 132 positioned therebetween. The motorized star wheel airlock 132 drops material through an air gap 134 between the first and second feed auger sections 128, 130 to improve the air seal and reduce the chances for burn back. The air lock 132 is more important for granular, or other, materials that do not naturally compact when conveyed by an auger.

As mentioned above, and in accordance with a preferred embodiment, the feed auger 126 is split into first and second auger sections 128, 130 with an airlock 132 positioned there between. After passing through the first auger section 128, airlock 132 and second auger section 130, the carbonaceous feedstock enters the pyrolytic reactor chamber 116, which houses a rotating auger 134 or some other mixing device. The carbonaceous feedstock is formed into plugs as the feedstock is conveyed by the first and second auger sections 128, 130. The formation of plugs within the first and second auger sections 128, 130 in combination with the airlock 132 excludes air from the reactor chamber 116. Where burn-back is not a concern, the feeding system may consist simply of a single feed auger or multiple augers feeding into the reactor chamber or other feeding devices. In accordance with a preferred embodiment of the present invention, the heat carrier 121 is hot steel shot, although a variety of heat carriers may be utilized without departing from the spirit of the present invention.

In accordance with a preferred embodiment, the feedstock is injected into the bed of downwardly flowing heat carrier 121 or, alternatively, above the bed of downward flowing heat carrier 121. Char, ash and the heat carrier 121 exit the pyrolytic reactor chamber 116 via a separation and recovery mechanism 120 in which the heat carrier 121 is recovered for further use and separated from the char. Once the char and heat carrier 121 are separated, the char (which contains the feedstock ash) is passed to a char storage hopper 136 via an auger 137 (or some other conveying mechanism). From there, char product is removed and, as needed for process heat, a portion of the char is sent to a char/syngas burner (or furnace) 118. In particular, char is separated out from the heat carrier 121 by the separation and recovery mechanism 120, and conveyed via an auger 137 to a lock hopper 136 for storage.

As briefly mentioned above, the char and heat carrier mixture exiting the pyrolytic reactor chamber 11 6 are immediately separated. As those skilled in the art will appreciate, separation is impacted by the physical and chemical properties of the char and heat carrier 121. In accordance with a preferred embodiment, a stationary screen or moving screen (for example, including trommel or shaker screens) is used to separate the char and heat carrier 121 based upon relative particle size. With reference to FIG. 4, a trommel screen 138 is employed in accordance with a preferred embodiment. The trommel screen 138 includes an open ended, slightly inclined rotating horizontal cylinder 140 whose outer surface is covered with a screen 144. The opening size of the screen 144 is changed over the length of the cylinder 140 with hoppers 146 placed beneath the different screen sections 144a, 144b in order to recover and keep separate the various particle sizes. More particularly, the cylinder 140 in accordance with the present invention includes a first section 144a with a fine screen shaped and dimensioned for the passage of char therethrough and a second section 144b with a more coarse screen shaped and dimensioned for the passage of heat carrier 121 therethrough.

Oversize particles may pass the entire length of the cylinder 140 and drop off the exit end 148, where they are recovered separately. Screen opening size, speed of screen rotation, size of screen surface area, screen diameter, angle of screen inclination and other factors are some of the control parameters that may be adjusted to control screening effectiveness for separation of the char and heat carrier 121.

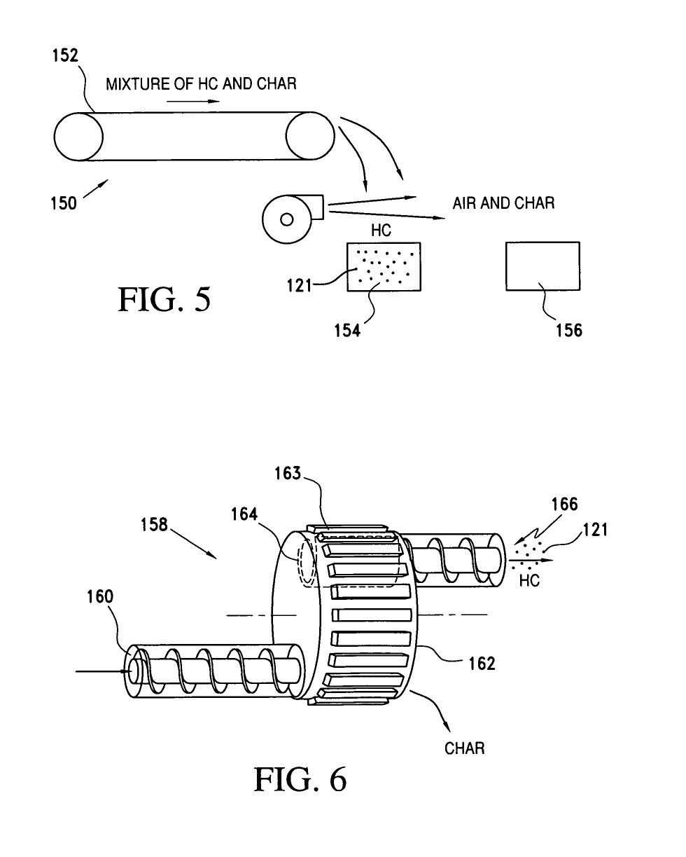

In accordance with an alternate embodiment, and with reference to FIG. 5, an air classifier system 150 may be employed for the separation of char and heat carrier 121. The air classifier system 150 uses heat carrier 121 and char particle weight differences to facilitate the separation thereof In accordance with a preferred embodiment, the air classifier system 150 is implemented by conveying the heat carrier 121 and char mixture with a conveying mechanism 152 and letting the mixture drop off the end of the conveying mechanism 152 where it would be subjected to rapidly moving air streams. The heavier heat carrier 121 particles fall immediately to a bin 154 substantially directly below the end of the conveyor 152, while the lighter char particles are conveyed by the air stream to a settling chamber 156 where they slow down and settle out.

In accordance with yet a further separation technique, and with reference to FIG. 6, a magnetic separation system 158 may also be employed for the separation of char and heat carrier 121. In accordance with a preferred embodiment, the magnetic separation system 158 utilizes a heat carrier 121 that can be attracted to a magnet and thus separate the heat carrier 121 from the char. More particularly, the separation system 158 includes an inlet 160 and a rotating magnetically active drum 162. The heat carrier 121 is attracted to the magnetically active drum 162 (which includes magnets 163 mounted along the outer surface of the drum) and binds thereto, while the char passes through the drum 162 and out of the separation system 158 where it is collected for use or further processing. The bound heat carrier 121 is removed from the drum 162 as it rotates via a scraper 164 which forces the heat carrier 121 off the drum 162 and into a collection system 166 for recycling of the heat carrier 121.

In accordance with an alternate embodiment, it is contemplated the magnets may be mounted stationary just beyond the surface of the rotating drum causing the heat carrier to be held against the rotating drum as it turns. Stationary magnets would only be positioned along a portion of the rotating drum's surface (reducing the number of magnets needed) and ending at the top of the drum, causing the heat carrier 121 to be released as the rotation of the drum carries the heat carrier 121 away from the influence of the magnets.

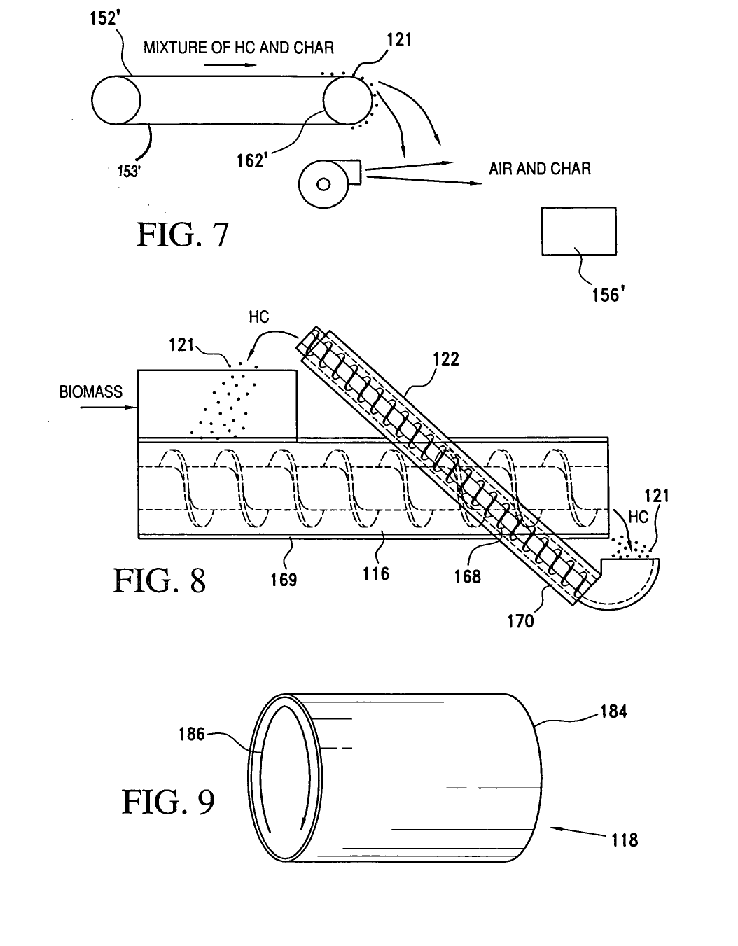

Referring to FIG. 7, a hybrid separation and recovery system is disclosed combining the features of the air classifier system disclosed with reference to FIG. 5 and the magnetic separation system disclosed with reference to FIG. 6. In accordance with this embodiment, separation is achieved using a magnetic head pulley 162′ on the conveying mechanism 152′. If magnetized heat carrier 121 is used, the heat carrier 121 will follow the belt 153′ of the conveying mechanism around the head pulley 162′ before dropping off into a bin (not shown). The lighter char is then thrown forward into a settling chamber 156′.

Separation of the char and heat carrier may also be accomplished by using electrostatic charges to attract the char and thereby separate it from the heat carrier. The characteristics of the char particles, particularly size, versus the heat carrier, allow for separation of the char particles from the heat carrier. The collected char particles can then be periodically removed from the plates or surfaces by a number of means, such as rapping the plates, reversing the charges, and other means.

It is also contemplated, separation of the char and heat carrier may be accomplished by using a cyclone, typically oriented vertically, whereby the heat carrier and char are conveyed into the cyclone by a rapidly moving gas stream, or other means, and separated by density differences of the respective particles. Those skilled in the art will appreciate that these methods may be used separately or in combination with other methods.

By implementing the separation and recovery of the char as outlined above, the following improvements are noted. The excess char may be sold as a co-product. Char can have values of over $100 per ton and, for wood, can be in the range of 25% of the incoming dry weight of the wood. For poultry litter, it can be in the range of 45% of the incoming dry weight of poultry litter and can have values over $180 per ton. Thus, the separated and recovered char can represent a substantial revenue stream.

In addition, removal of the char allows for better process temperature control as the amount of char fuel can be precisely metered into a burner based upon process heat requirements. The removal of char also allows the char/syngas burner 118 to be placed outside the process loop and does not require the introduction of air into the process material flows or process loop. Therefore, the char/syngas burner 118 is not impacted by other process conditions and allows better control of combustion air since primary and secondary air can be introduced and controlled separately. Since the char/syngas burner 118 is separate from the process, it simplifies recovery of ash after combustion of the char. For example, one method is the use of a cyclone and/or a bag house in the burner stack emission stream. In fact, one design uses a burner that is also a cyclone so as the char is burned, the ash is automatically separated from the stack gases and recovered.

For various reasons, clinkers may sometimes be formed in the process or foreign objects may be introduced into the system. The use of a char/heat carrier separation system allows the removal of these oversize or foreign particles before they cause a problem. More particularly, and with reference to the trommel screen separation and recovery mechanism 138 discussed above, the screen 144 of the separation and recovery mechanism 138 is constructed with a fine mesh screen along the first section 144a at the initial length of the screen 144 to remove fine char particles. The fine mesh screen is followed by a coarser screen along the second section 144b at the final length of the screen 144 with openings just large enough for the heat carrier to pass therethrough. The clinkers (as well as stones, tramp metal, and other large particles) drop off the exit end 148 of the screen 144 where they may be recovered and removed by various means.

As discussed above, the char and heat carrier 121 are separated. Once the char has been separated from the heat carrier 121, the separated heat carrier 121 is transferred to and readily reheated in a heat exchanger 122 associated with the pyrolytic reactor chamber 116 and the char/syngas burner 118. Char acts as an insulator and, since it typically has particle sizes smaller than the heat carrier 121, it tends to fill the voids between the heat carrier 121 particles thus effectively insulating the heat carrier 121 particles. Char can also tend to act as a “flowable fill” when mixed with the heat carrier 121, which may then cause the char/heat carrier mixture to set up when a conveying auger is stopped. By separating the heat carrier 121 and char, especially if performed as soon as possible after the reactor chamber 116, this inefficiency is eliminated and the heat carrier 121 may be reheated in a much more efficient manner.

As such, the heat carrier 121 is coupled with a heat exchanger 122 that is heated by the separately controlled char/syngas burner 118 as previously described. The heating of the heat carrier 121 can, therefore, be better controlled. For example, and with reference to FIGS. 2 and 8, one or more augers 168 may be used to move the heat carrier 121 through the heat exchanger 122 and back to the reactor chamber 116 for reuse thereof. The auger diameter, length, rotational speed, and other factors (all of which effect heat carrier 121 residence time and heat exchanger efficiency) may be varied to suit specific applications. In addition, the heat exchanger 122 shell temperature and the heating of the shell in the counter current or co-current mode may also be adjusted to control the efficiency of the heat transfer process. In addition, so long as the heat exchanger 122 throughput is sized to match the process loop heat carrier mass flow recirculation requirements, the exchange process can be controlled independently of the rest of the process.

As those skilled in the art will certainly appreciate, the heat exchanger 122 may be formed as part of the heat carrier recirculation loop, thus combining the function of the heat exchanger 122 so that it can be both a heat exchanger and a conveyor (see FIGS. 2 and 8). This simplifies construction and reduces capital and O&M costs for the system. More particularly, the heat carrier 121 is returned to the reactor chamber 116 via a heat exchanger 122 composed of a jacketed auger 168. The jacketed auger 168 provides a flow path for the heat generated by the char/syngas burner 118. In this way, the heat carrier return (or heat exchanger) 122 functions as both a heat carrier return mechanism and a heat exchanger designed to heat the heat carrier 121 prior to being reintroduced into the reactor chamber 116. Heat exiting the heat exchanger 122 may be directed to a jacket 169 surrounding the reactor chamber 116 to provide additional heat transfer to the reactor chamber 116 and then directed to the dryer 12 (see FIG. 1) to provide heat for drying. Alternatively, the heat from the heat exchanger may be ducted directly from the heat exchanger to the dryer or recovered for other uses.

Gas and vapor depart the pyrolytic reactor chamber 116 via a tube 114 and may be directed to a condenser system 172 or, alternatively, the gas and vapor—comprising a syngas-may be used for energy directly without a condensing system. Condensed liquids, for example, bio oil, are collected by virtue of a liquid transfer pump or pumps.

The gas and vapor is directed out of the pyrolytic reactor chamber 116 via an exit tube 114. Prior to entering the condenser system 172, the gas and vapor may be cleansed by passing it through a char trap 178 and a tar trap 180, as well as other suitable cleansing devices. Vapor and gaseous material depart the pyrolytic reactor chamber 116 via the gas exit chamber 114 and are ultimately directed to a condenser system 172. Condensed liquids (for example, including bio oil) from the condenser system 172 are transferred to storage tanks 182 by gravity or by virtue of one or more liquid transfer pumps.

The uncondensed gases, which can contain considerable energy value (for example in the form of syngas), are also collected and used for energy by directing them to the char/syngas burner 118 or for applications independent of the pyrolysis process. The uncondensed gases may be used for energy by using the uncondensed gases to fuel an engine (for example, reciprocating internal combustion engine, combustion turbine, or Stirling engine) to provide mechanical and/or electrical power and heat for the process. Depending upon the type of feedstock and the feedstock moisture content, there can be enough energy in the uncondensed gas to supply all the electrical and/or heat requirements of the present system 100. The use of the uncondensed gas can thus minimize or eliminate the need for external fuel sources which reduces operating expense and may allow the units to be operated in remote areas (for example, military camps and/or logging camps).

Conventional condenser designs subject vapors exiting the reactor chamber to either a cold surface or a cold liquid stream (which may be bio oil, water, or another suitable liquid stream) to cause the vapors to condense to create a single liquid product that is a mixture of many chemicals. Due to the physical and chemical characteristics of the liquid product generated, the resulting liquid pyrolysis oil product using these methods may have limited uses and thereby limitations in value.

In accordance with a preferred embodiment, and with reference to FIG. 12, one or more fractional condensation columns 300 may, therefore, be employed in accordance with a preferred embodiment of the present invention. The fractional condensation column(s) 300 include a series of plates 302a-i which are connected directly to the reactor chamber(s) 116 (typically above the reactor chamber 116 to take advantage of the tendency of the warm, low-density vapor to rise) to create an integral unit so that the gas and vapor generated by the process in the reactor chamber 116 is continuously and immediately passed through the condensation columns 300.

More particularly, the condensation column 300 has internal packing, or, more typically, horizontal plates 302a-i (for example, sieve trays) similar to a distillation tower to create points for condensation of the vapors to occur as the vapors pass through the previously condensed liquids with some reflux liquid returned to the highest plate. The temperature inside the condensation column 300 will decrease as the vapors flow upward and the composition of the liquids on the plates 302a-i will reflect the boiling point of the liquid as in a similar fractional distillation column. Additionally, if needed, the internal temperature of the condensation column 300 can be controlled by heating or cooling systems placed around the condensation column 300 at different heights. Thus, the liquid on each plate 302a-i will have a different chemical composition as reflected by the boiling point of the liquid. Liquids from the different plates 302a-i may be extracted continuously as the reactor 116 is fed feedstock continuously and gas and vapor is produced and fed continuously to the condensation column. The upward flow of gas and vapor from the reactor 116 may be aided by a recycling stream consisting of the non-condensable gas from the process or by another suitable gas.

By coupling the reactor chamber with a fractional condensation system as described above, a simplified, continuous method of recovering various chemicals from condensed liquid is achieved. This minimizes or eliminates the need for additional processing of the liquid (which requires additional equipment, energy and cost) in order to recover chemicals from the liquid product. It also reduces cost since an additional extraction, upgrading, separation, and/or other system is not necessary to recover the chemicals and multiple, individual condensers are not required.

As discussed above, a char/syngas burner 118 is utilized in burning the separated and gathered char for use in heating the heat carrier 121 and thereby the pyrolytic reactor 116. The char is combusted in a combustion device that is outside the process loop. Referring to FIG. 9, the device may be, for example, a fluidized bed burner or a suspension burner that could be in the form of a horizontal or vertical cylinder, or air spreader stoker or other device. In accordance with a preferred embodiment of the present invention, the char/syngas burner 118 includes a refractory lined combustion chamber 184 through which char is blown along a tangent with the combustion air. The char is combusted while suspended by centrifugal force against the cylinder walls 186. Although a horizontally oriented combustion chamber 184 is disclosed in accordance with a preferred embodiment of the present invention, those skilled in the art will appreciate that a vertical combustion chamber could be employed without departing from the spirit of the present invention.

By utilizing a better designed char/syngas burner 118, better efficiency in using the char is provided and process heat for the plant is provided. Both types of systems provide for very rapid burning response because only a very small amount of fuel is in the burner 118 at any one time. The fluidized bed system also has the distinction of infinite turndown since one can stop feeding fuel to it for a period of time and, so long as enough heat is retained in the refractory insulation and bed material to ignite incoming fuel, can start up automatically when fuel is again fed into the burner. As those skilled in the art will certainly appreciate, a variety of burner configurations are commercially available. However, in accordance with a preferred embodiment some or all of the char is burned outside the process loop to provide some or all of the process heat.

As discussed above, a pyrolytic reactor chamber 116 is utilized in accordance with the present invention. In accordance with the present reactor design, the biomass is conveyed into the reactor chamber 116 with an auger or some other feed mechanism 126. The heat carrier 121 enters the reactor chamber 116 above the biomass so as to sweep the lighter biomass particles into the vapor/gas stream downward with it. Alternatively, the biomass may be fed directly into a bed in the reactor chamber 116 consisting of the heated heat carrier 121. The reactor chamber 116 throat cross sectional area may be increased in size to decrease the velocity of the vapor/gas so as to minimize the particulate carryover. The inside of the reactor chamber 116 may be lined with refractory material to increase its efficiency and the inside of the reactor chamber 116 is designed to be free of protrusions which may impede flow of materials or form a basis for buildup of slag.

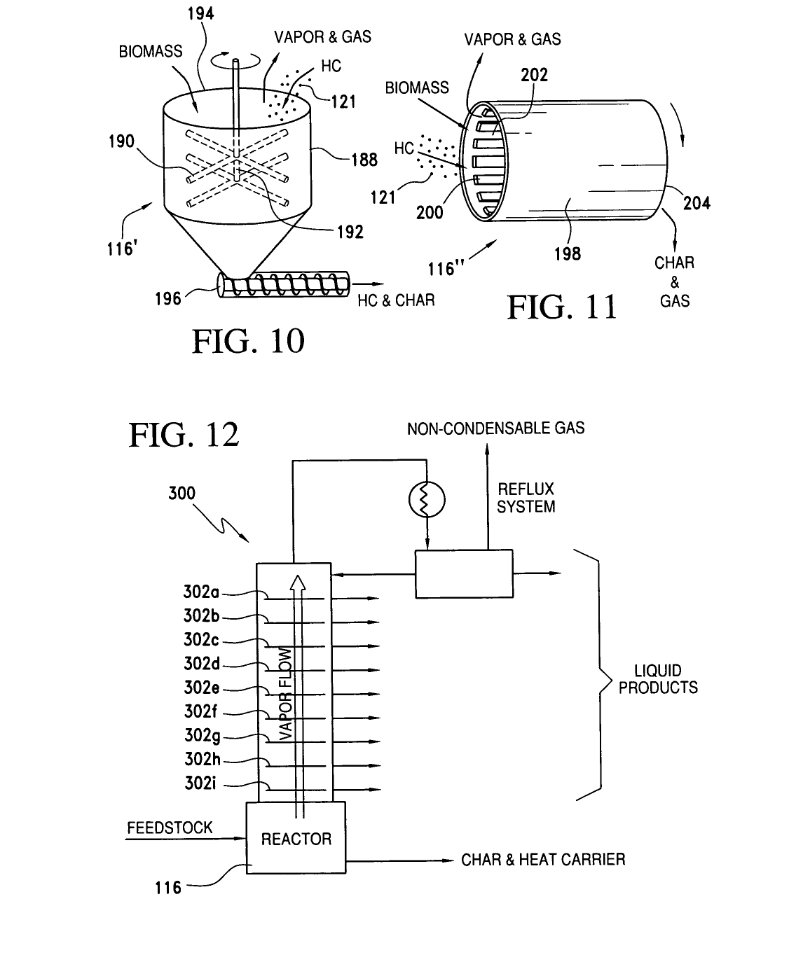

Various methods of mixing the biomass and the heat carrier 121 in the reactor chamber 116 can be used as a replacement for a traditional horizontal auger configuration. For example, a stirred tank reactor 116′ may be utilized or a rotating cylinder 116″ may be utilized (see FIGS. 10 and 11, respectively). More particularly, the stirred tank reactor 116′ includes a tank 188 into which the biomass is dumped. Within the tank may be positioned a series of agitators 190 mounted upon a rotating shaft 192. The agitators 190 rotate within the tank 116′ to mix the biomass such that vapor and gas exit the top 194 of the tank 116′ and heat carrier 121 and char exit the bottom 196 of the tank 116′. With regard to a rotating cylinder reactor 116″, the reactor includes a cylinder or drum 198 oriented substantially horizontally. Material flow through the drum 198 may be assisted with a slight downward tilt in the direction of the desired biomass flow or by the positioning of flighting internal to the drum's surface. As those skilled in the art will certainly appreciate, flighting is essentially a series of internal paddles, which may be continuous or discontinuous, fastened to the inside wall of the drum. The flighting lifts the material as the drum rotates and allows better mixing of the biomass particles and heat carrier as the mixture falls back to the bottom of the drum. The drum 198 includes a series of internal flights 200 for mixing of the biomass as it is passed therethrough. As the drum 198 rotates and the biomass is rotated, for example, vapor and gas exit the drum at the proximal end 202 thereof while the char and heat carrier 121 exit at the distal end 204 thereof along the line of flow for the biomass. Although various reactor designs are contemplated in accordance with a preferred embodiment of the present invention, other reactor designs including variations of these examples could certainly be implemented without departing from the spirit of the present invention.

In addition, the char/heat carrier/oversized particle screening system can be incorporated into the reactor design in several ways. This eliminates the need to have a separate screening system and thus simplifies construction. For example, if the reactor consists of a single auger in a trough or tube, the later part of the trough or tube can be a screen that can be of different size openings to accommodate the separation of fine char particles, heat carrier particles and oversized particles. Alternatively, the screen could be a trommel screen on a common shaft with the horizontal mixing auger in the reactor.

The present reactor design allows for quick vaporization of very small sized feedstock particles upon their entry into the reactor. The resulting very small char particles may be swept upward by the flow of gas and vapor and may form deposits on the ducting and condenser surfaces that cause plugging of passages. They may also contaminate the bio oil. By injecting the biomass beneath the heat carrier or into a heat carrier bed within the reactor chamber, these particles are swept downward by flow of the heat carrier. The reactor throat cross sectional area may also be increased in size to decrease gas and vapor flow rates from the reactor and thereby decrease the amount of particulate carryover in the gas and vapor stream. The inside of the reactor may be lined with refractory to provide better insulation and a hotter, more even temperature environment for the reactor. The inside of the reactor throat is smooth so that falling biomass does not become hung up on it in any manner. If, the screen and reactor are a common system, the need for separate screening system is eliminated and construction of the plant is simplified.

With regard to the condenser, a settling chamber or cyclone may be added between the reactor and the condenser to remove particulates out of the gas/vapor stream before they reach the condenser system. A heat transfer fluid may be used for controlling the condenser temperature. This heat transfer fluid may be used as a direct contact condenser or in an indirect contact condenser such as a shell and tube condenser. Finally, the condenser may utilize non-stick surfaces to minimize or prevent tar/char build up.

The settling chamber of the condenser minimizes the amount of char the gets into the bio oil. The use of the heat transfer fluid simplifies the control of the condenser system since one can obtain heat transfer control fluids that go up to several hundred degrees Fahrenheit without boiling or cracking. By using proportional controls, one can control the oil temperature, and hence condenser temperature, very precisely. Finally, by using non-stick materials or coatings, the formation of tar build up and subsequent plugging can be minimized or eliminated.

While various preferred embodiments have been shown and described, it will be understood that there is no intent to limit the invention by such disclosure, but rather, is intended to cover all modifications and alternate constructions falling within the spirit and scope of the invention as defined in the appended claims.

1. A system for the conversion of carbonaceous feedstocks into useful sources for energy, chemicals, or other material, comprises:
a reactor chamber for receiving carbonaceous feedstock and heat carrier for processing of the feedstock in the generation of useful sources for energy, chemicals, or other material;
a char separation and recovery mechanism linked to the reactor chamber for separating char produced as a result of processing of feedstock within the reactor chamber from heat carrier;
a condenser in communication with the reactor chamber for receiving gas and vapor from the reactor chamber to separate and recover a liquid product and non-condensable gases; and
a furnace linked to the char separation and recovery mechanism for burning the gases and char as needed to provide energy for operation of the system.

2. The system according to claim 1, wherein the liquid product generated by the condenser is bio oil.

3. The system according to claim 1, further including a dryer in communication with the reactor chamber.

4. The system according to claim 3, wherein a feed mechanism transfers the feedstock from the dryer to the reactor chamber.

5. The system according to claim 4, wherein the feed mechanism includes a central air lock between first and second feed sections.

6. A method for the conversion of carbonaceous feedstocks into useful sources for energy, chemicals, or other material, comprises the following steps:
processing carbonaceous feedstock and heat carrier in a reactor chamber;
separating and recovering char produced as a result of processing of feedstock within the reactor chamber from heat carrier;
separating and recovering liquid product and non-condensable gases from gas and vapor emitted by the reactor chamber; and
burning the gases and char as needed to provide energy for operation of the method.

7. The method according to claim 6, wherein the liquid product generated by the condenser is bio oil.

8. The method according to claim 6, further including the step of drying the feedstock prior to the step of processing in the reactor chamber.

9. The method according to claim 8, wherein a feed mechanism transfers the feedstock to the reactor chamber.

10. The system according to claim 9, wherein the feed mechanism includes a central air lock between first and second feed sections.
